(19) United States
(12) Patent Application Publication
(10) Pub. No.: US 2006/0149927 A1
(43) Pub. Date: Jul. 6, 2006

(54) Processor capable of multi-threaded execution of a plurality of instruction-sets

(76) Inventors: Eran Dagan, Tel Aviv (IL); Asher Kaminker, Tel Aviv (IL); Gil Vinitzky, Azor (IL)

Correspondence Address: Edward Langer;Shiboleth Yisraeli Roberts & Zisman & Company, 60th Floor, 350 Fifth Avenue, New York, NY, 10118, US

(21) Appl. No.: 10/536,435

(22) PCT Filed: Nov. 24, 2003
(86) PCT No.: PCT/IL03/00991

§ 371 Date: May 26, 2005

Related U.S. Application Data
(60) Provisional application No. 60/429,014, filed on Nov. 26, 2002.

(51) Int. Cl. G06F 9/44

(52) U.S. Cl. 712/43; 712/229

(57) ABSTRACT

A processor (100) capable of receiving a plurality of instructions sets from at least one memory (50), and capable of multi-threaded execution of the plurality of instruction sets. The processor includes at least one decoder (130) capable of decoding and interpreting instructions from the plurality of instruction sets. The processor also includes at least one mode indicator (140) capable of determining the active instruction-set mode, and changes modes of a software or hardware command and at least one execution unit (110) for concurrent processing of multiple threads, such that each thread can be from a different instruction set, and such that the processor processes the instructions according to the active instruction-set, which is determined by the mode indicator (140), and by allowing concurrent execution of several threads of several instruction sets.

### FIELD OF THE INVENTION

The present invention relates generally to processor or computer architecture, and particularly to multiple-threading processor architectures executing multiple native computer languages.

### BACKGROUND OF THE INVENTION

Multilingual processors are processors that are capable of executing instructions belonging to a plurality of instruction-sets. The multilingual processor is targeted for applications that require, for effective execution, instructions belonging to distinctly different architectures. A multilingual processor may also refer to instructions belonging to similar architectures, or an instruction set and its subset. A common occasion wherein a multilingual processor is needed is an application that involves digital signal processing (DSP) and general computing. A single architecture implementation results in poor overall performance. A single processor that can alternately operate as a DSP processor or as a general purpose processor, adapting itself to the characteristics of the program being executed, would improve the system's efficiency.

The operational approach of a multilingual processor is that only one instruction set is activated at any given time. A mode indicator determines the active instruction set. The active mode may be determined by a software programmable mode register (or mode indicator or bit-field) or by a hardware signal. Generally, the mode change is followed by a control signal to the decoder and to the execution unit, instructing them to interpret and execute the subsequent instruction stream as belonging to the new instruction set.

A bilingual processor may be one that executes both Java bytecodes and legacy binary code based on a reduced instruction set computer (RISC) instruction set. By executing legacy code, in addition to Java, the large code base of existing software can be used on the bilingual processor without the need for recompiling or rewriting significant portions of code. For instance, code written in a high level language such as C, is compiled to a legacy binary native language, while Java is compiled to Java bytecodes. This avoids a huge software effort to develop a C to Java bytecode compiler, recompiling the C code, or rewriting the existing C code in Java. Hereby, high performance Java and C source codes coexist with minimal software resources. Thus, an application can be rapidly deployed regardless of the language in which the applications are written. Moreover, even when new applications are programmed the best of the languages for each given task may be utilized.

Another class of multilingual machines support several instruction sets that are different binary representations of similar or identical assembly instructions or selected subsets of the same assembly instructions, where each language is coded differently for different optimization criteria. This allows assembly of different modules of the application into performance tuned instruction opcodes, or code density tuned instruction opcodes, respectively.

Another example of a processor that operates in more than one instruction set is the VAX11 of Digital Equipment Corporation. The VAX11 processor has a VAX instruction mode and a compatibility mode that enables it to decode instructions of programs originally designated for the earlier PDP11 computers. Another example is the ARM11 processor that supports a classic RISC instruction set and a thumb mode instruction set. The ARM11 processor allows execution of a subset of the RISC instruction set, with a new set of opcodes that provides better code density. Such processors have typically incorporated separate instruction decoders for each instruction set or a single decoder whose operation depends upon the active mode indicator, i.e., the active instruction set.

A processor that is designed to allow instruction level parallelism is a multithreaded processor. A multithreaded processor provides additional utilization of more fine-rain parallelism. The multithreaded processor stores multiple contexts in different register sets on the chip. The functional units are multiplexed between the threads. Depending on the specific multithreaded processor design, it comprises a single execution unit, or a plurality of execution units and a dispatch unit that issues instructions to the different execution units simultaneously. Because of the multiple register sets, context switching is very fast. An example of such a processor is shown in a provisional patent application entitled “An Architecture and Apparatus for a Multi-Threaded Native-Java Processor” assigned to common assignee and incorporated herein by reference for all it contains.

Superscalar parallel processors generally use the same instruction set as the single execution unit processor. A superscalar processor is able to dispatch multiple instructions each clock cycle from a conventional linear instruction stream. The processor core includes hardware, which examines a window of contiguous instructions in a program, identifies instructions within that window which can be run in parallel and sends those subsets to different execution units in the processor core. The hardware necessary for selecting the window and parsing it into subsets of contiguous instructions, which can be run in parallel, is complex and consumes significant processing capacity and power. The level of parallelism achievable in this way is limited and application dependent. Thus, the expected performance gain, compared to the capacity and power overhead is restricted.

Although there is an increasing demand for high speed low cost processors, that would support multiple instruction sets, and provide further multithreading support for languages such as Java, such processors are not found in the art.

Therefore, it would be advantageous to provide a processor that supports a multiple instruction set in a multithreaded environment.

### SUMMARY OF THE INVENTION

Accordingly, it is a principle object of the present invention to provide a processor that supports a multiple instruction set in a multithreaded environment.

It is a further object of the present invention to provide a processor capable of concurrently executing several threads, where each thread is executed in accordance with its own mode.

It is another object of the present invention for the processor to provide the processing capability of several different processors, with different programming models, all running in parallel.

It is one further object of the present invention to provide a processor that is dynamically programmed to process threads in any combination of instruction set modes.

A processor is disclosed that is capable receiving a plurality of instructions sets from at least one memory, and capable of multi-threaded execution of the plurality of instruction sets. The processor includes at least one decoder capable of decoding and interpreting instructions from the plurality of instruction sets. The processor also includes at least one mode indicator capable of determining the active instruction-set mode, and changes modes according to a software or hardware command and at least one execution unit for concurrent processing of multiple threads, such that each thread can be from a different instruction set, and such that the processor processes the instructions according to the active instruction-set, which is determined by the mode indicator, and by allowing concurrent execution of several threads of several instruction sets.

For the purpose of this document the following terms shall have the meaning defined herein:

instruction Set is a set of binary codes, where each code specifies an operation to be executed by the processor;

instruction stream is a sequence of instructions that belong to a program thread, task, or service;

task is one or more processes performed within a computer program;

thread is a single sequential flow of control within a program; and

instruction is a binary code that specifies an operation to be executed by the processor. An Instruction includes information required for execution, such as opcode, operands, pointers, addresses and condition specifiers.

Additional features and advantages of the invention will become apparent from the following drawings and description.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1 is an exemplary block diagram of the provided processor, in accordance with one embodiment of the present invention;

FIG. 2 is an exemplary flowchart for multi-threaded execution of a plurality of instruction sets, in accordance with one embodiment of the present invention;

FIG. 3 is a diagram showing an example of executing four threads that belong to two different instruction sets;

FIG. 4 is an exemplary block diagram of the provided processor, in accordance with one embodiment of the present invention; and

FIG. 5 is a diagram showing an example of executing four threads that belong to two different instruction sets.

### DETAILED DESCRIPTION OF THE INVENTION

The invention will now be described in connection with certain preferred embodiments with reference to the following illustrative figures so that it may be more fully understood. References to like numbers indicate like components in all of the figures.

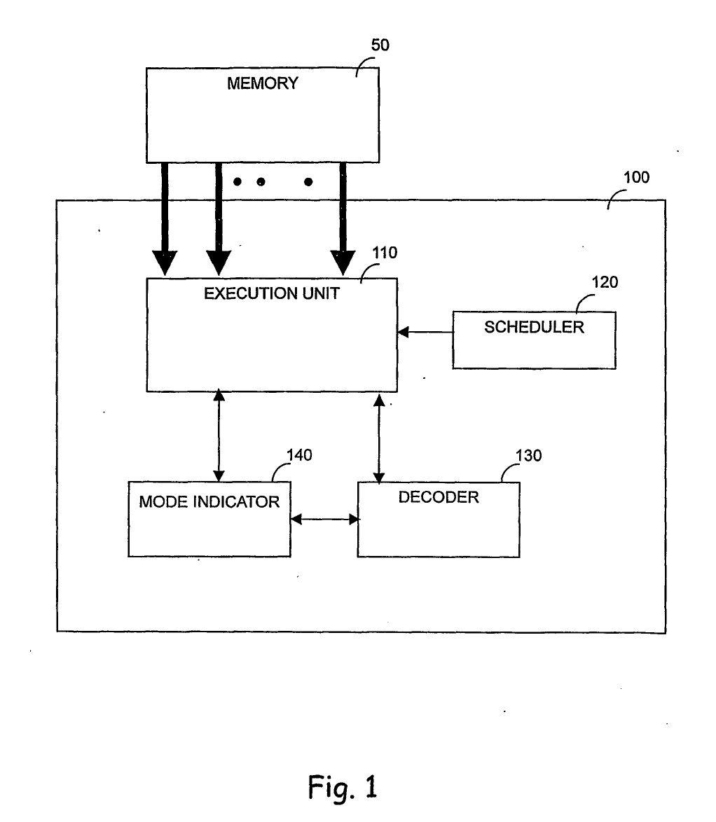

Reference is now made to FIG. 1, which is an exemplary block diagram of multithreaded processor 100 capable of executing multiple instruction sets in accordance with one embodiment of this invention, is shown. Processor 100 comprises of execution unit (EU) 110, scheduler 120, decoder 130, and mode indicator 140. Memory 50 includes instructions belonging to a plurality of threads waiting to be executed. Memory 50 consists of a plurality of memory banks or memory segments. In one embodiment of this invention the instructions are loaded into memory 50 prior to the application execution. The instruction sets supported by processor 100 include but are not limited to digital signal processing (DSP), reduced instruction-set computer (RISC), Microsoft intermediate language (MSIL), Java bytecodes, and combination thereof. The reference to the instruction sets herein is general and instructions specific to any given or newly developed architecture may be used. Processor 100 further includes a mechanism (not shown), allowing for the context switching to be performed instantly. The mechanism may be implemented using multiple register sets, multiple sub sets of the machine state registers, or a subset of the machine state register set, in addition to a shared register pool. The shared register pool is allocated according to the temporary requirements of the executed threads.

EU 110 is capable of concurrently executing a plurality of threads and processing them as may be required. In one embodiment of this invention EU 110 comprises a plurality of pipeline stages. EU 110 receives a plurality of instruction streams by fetching instructions from memory 50, and processing them as may be required. Each of the instruction streams includes a sequence of instructions from a program thread. The active instruction stream (e.g. thread) is determined by scheduler 120. Scheduler 120 operates according to a scheduling algorithm including, but not limited to round robin, weighted round robin, a priority based algorithm, random, or any other selection algorithm, for instance, a selection algorithm that is based on the status of processor 100.

Decoder 130 decodes and interprets instructions that belong to a plurality of instruction sets. At any given time only one instruction set is activated. Namely, decoder 130 decodes instructions and interprets the instruction opcodes in a way that corresponds to the active instruction-set mode.

In one embodiment, decoder 130 is further capable of mapping an instruction of a first instruction set into an instruction of a second instruction set. The first and second instruction sets may be different instruction sets, or the first instruction set may be a subset of the second instruction set. Mode indicator 140 determines the active instruction-set mode, and changes modes according to a programmable mode change message or an external hardware signal. The mode change signal may be at least one of a dedicated instruction, a dedicated combination of instructions, or a dedicated combination of bit-fields within an instruction or within any entity associated with the instruction (e.g. operands, pointers, addresses). The mode indicator can include a mechanism for automatically changing the active instruction-set mode. The operation of switching the instruction mode can be done automatically or not: For example, for automatically switching there may be programming to switch each 10 clock cycles.

It should be noted that in some embodiments, mode indicator 140 may not be part of processor 100. In such embodiments, the determination of a change in mode is triggered by an external mode indication signal or by using an address decoder. The external mode indication signal is fed into decoder 130 and into EU 110. The address decoder correlates between the memory address of the instruction to be executed and the instruction-set. Namely, the active instruction set mode is determined by the memory location from which the instruction was fetched.

Processor 100 may be dynamically programmed to execute in any combination of instruction set modes. For example, if processor 100 is capable of executing four threads of two different instruction sets “A” and “B,” then processor 100 may be dynamically configured to process: four threads in mode “A,” or three threads in mode “A” and one thread in mode “B,” or two threads in mode “A” and two threads in mode “B,” and so forth. In order to allow such a configuration, a conventional system would require four processors of instruction-set “A” and additional four processors of instruction set “B.”

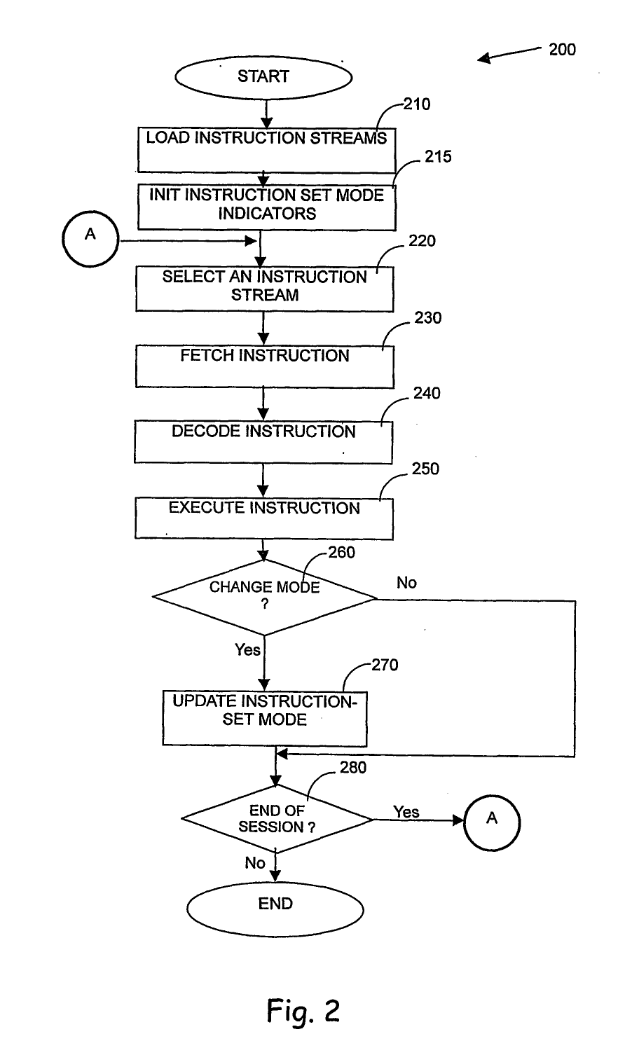

FIG. 2 is an exemplary flowchart for multi-threaded execution of a plurality of instruction sets, in accordance with one embodiment of the present invention. FIG. 2 is a flow chart 200 describing the method for multithreaded loading and processing of a plurality of instruction-sets by processor 100. The method concurrently executes multiple instruction streams (e.g., threads), in which each of the threads is executed in its own instruction-set mode. At step 210, processor 100 loads a plurality of instruction streams of the threads to be executed into memory 50. At step 215, all mode indicators are initialized to their default values. At step 220, a single instruction stream is scheduled for execution by scheduler 120.

The scheduling algorithm applied by scheduler 120 includes, but is not limited to, round robin, weighted round-robin, a priority based algorithm, random, or any other scheduling algorithm. At step 230, an instruction from the active instruction stream is fetched from memory 50. At step 240, decoder 130 interprets the opcode of the fetched instruction according to the active thread's instruction-set mode indicator.

At step 250, the processing of the instruction takes place, typically in EU 110. In one embodiment, the instruction processing is performed in accordance with the instruction-set mode. The instruction set mode is correlated to the executed thread and claim determined by mode indicator 140. At step 260, it is determined whether the instruction-set mode indicator should be changed. A mode change is triggered by a mode change message or a hardware signal.

For example, a mode change is performed if the previous executed instruction of the same thread was “SET MODE” instruction, if the mode bits indicate that the following instructions belong to a different mode, or if a hardware signal was received. If it was determined at step 260 that a mode change is required, then at step 270 the mode indicator is updated so that it indicates the new instruction-set mode for the currently active thread. Changing the instruction-set mode is followed by producing a control signal to decoder 130, informing it to decode and interpret the instructions of the active thread according to the new instruction set mode.

In one embodiment the control signal is also sent to EU 110. If mode change is not required, then the method continues at step 280. At step 280, it is determined whether the application execution has been completed. If so, the method is terminated, otherwise the method continues at step 220. In one embodiment mode indicator 140 determines if a change mode is required, prior to the instruction decoding (i.e. step 240). Namely, first mode indicator 140 determines to which instruction set the incoming instruction belongs and then sets the instruction-set mode indication to the appropriate value.

A detailed example of the processing method is provided below. As mentioned above in greater detail, processor 100 includes a mechanism, allowing for the context switching to be performed instantly.

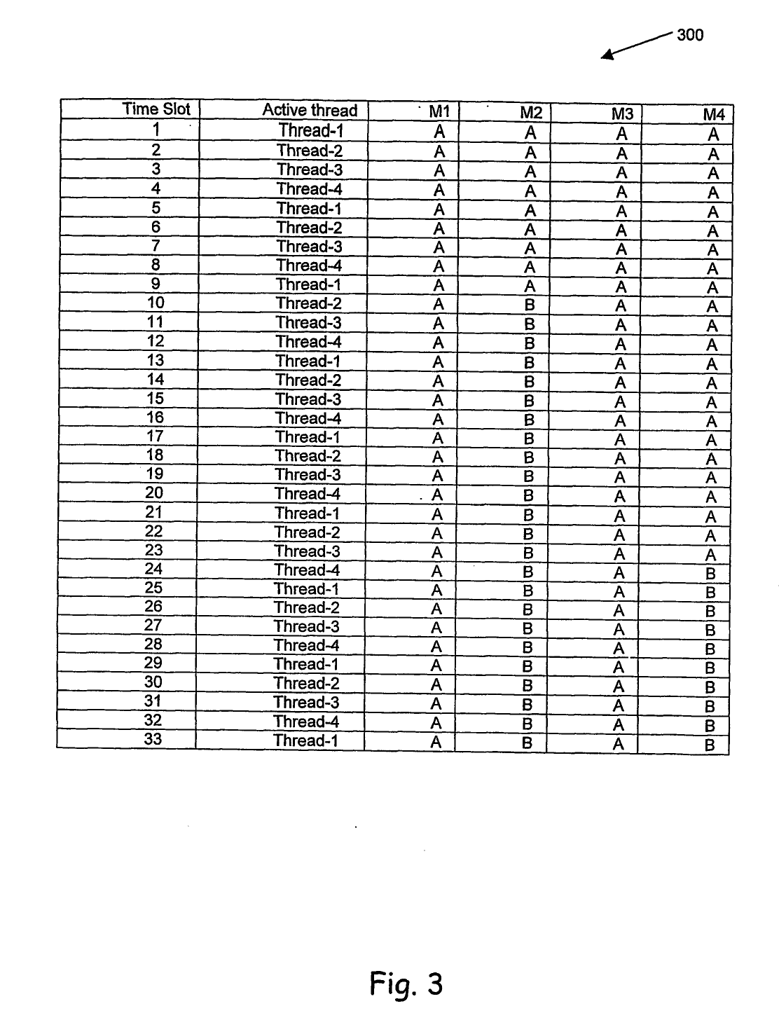

FIG. 3 is an exemplary diagram showing an example of executing four threads that belong to two different instruction sets 300. FIG. 3 is a non-limiting example showing the execution of four threads that belong to two different instruction-sets. The threads are chosen in a round-robin manner, i.e., thread 1 followed by thread 2 and so on. The example shows the processing of two instruction sets “A” and “B,” where the columns “M1” through “M4” represent the instruction-set mode indicators associated with thread-1 through thread-4 respectively. At startup the instruction-set modes of all threads are set to mode “A.” The time slots represent the execution time given to each thread.

At time slot 1, processor 100 fetches instructions of the active thread-1 from memory 50, pointed by thread 1's PC. The fetched instructions are decoded as instruction set “A.” At time slot 2, processor 100 fetches instructions of the active thread-2 from memory 50, pointed by thread 2's PC. The fetched instructions are decoded as instruction set “A.”

This process is repeated for all threads at time slots 3 through 9. At time slot 10, when thread-2 is activated, mode indicator 140 updates the instruction-set mode associated with thread-2 to mode “B,” as a result of a mode change message (e.g. “SET B”). Hence, starting from time slot 11 instructions that belong to thread-2 are decoded as instruction-set “B.” From this point, thread-1, -thread-3, and thread-4 run as instruction set “A,” and thread-2 runs as instruction set “B.” At time slot 24, when thread-4 is activated, mode indicator 140 updates the instruction-set mode associated with thread-4 to mode “B” as a result of mode change message (e.g. “SET B”).

Hence, starting from time slot 25, instructions that belong to thread-4 are decoded as instruction-set “B.” Starting from this time slot, until a new mode change message is decoded, thread-1 and thread-3 run as instruction set “A,” while thread-2 and thread-4 run as instruction set “B.” This process continues until the application is terminated. It should be noted that a time slot represents the time in which instructions are issued for execution, and not the time required to complete execution of a single instruction.

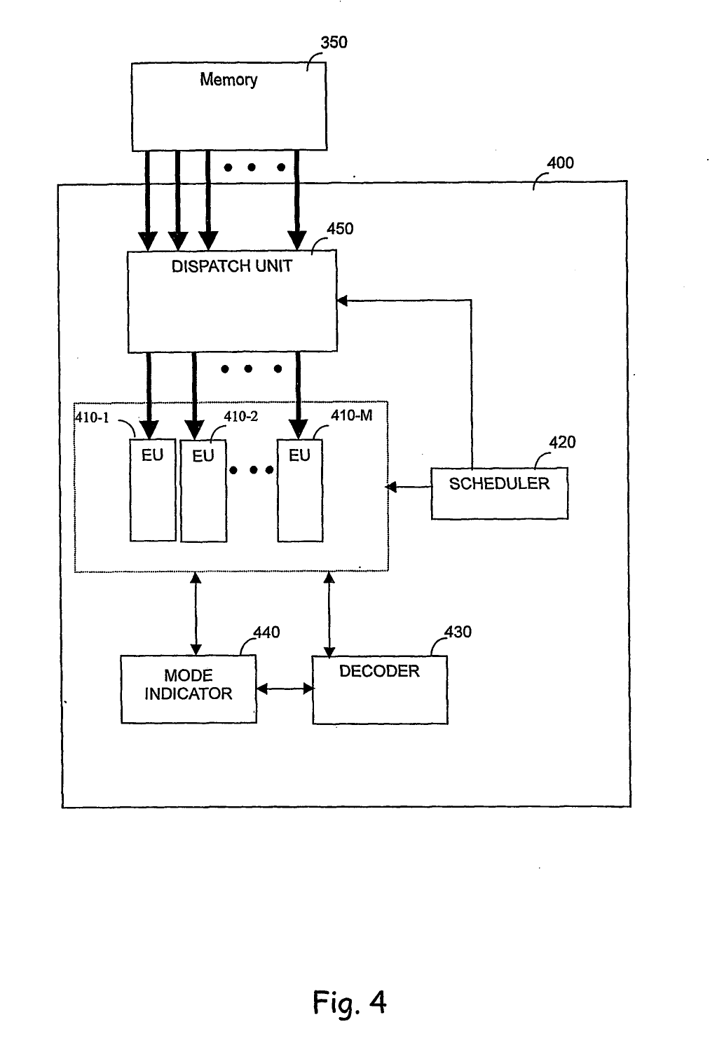

FIG. 4 is an exemplary block diagram of the provided processor, in accordance with one embodiment of the present invention. FIG. 4 is a block diagram of multithreaded processor 400 capable of executing multiple instruction sets. Processor 400 comprises a plurality of execution units (EU's) 410-1 through 410-M, scheduler 420, decoding means 430, mode indicator 440, and dispatch unit (DU) 450. Memory 350 includes instructions belonging to a plurality of threads waiting to be executed. Memory 350 consists of a plurality of memory banks or memory segments. In one embodiment of this invention the instructions are loaded into memory 350 prior to the application execution.

Processor 400 further includes a mechanism (not shown), allowing for the context switching to be performed instantly. The mechanism may be implemented using multiple register sets, multiple sub sets of the machine state registers, or a subset of the machine state register set, in addition to a shared register pool. The shared register pool is allocated according to the temporary requirements of the executed threads.

DU 450 receives a plurality of instruction streams by fetching instructions from memory 350, and dispatches them to execution by the EU's: 410-1 through 410-M, so that up to M instructions can be issued simultaneously. Each of the instruction streams includes a sequence of instructions from a program thread. The active instruction stream (e.g. thread) is determined by scheduler 420.

Scheduler 420 operates according to a scheduling algorithm including, but not limited to, round robin, weighted round robin, a priority based algorithm, random, or any other selection algorithm, for instance, a selection algorithm that is based on the status of processor 400. DU 450, determines the EU 410 that would execute the issued instruction, according to an issuing algorithm, usually based on optimization criteria.

Decoding means 430 decodes and interprets instructions that belong to a plurality of instruction sets. Decoding means 430 may include a plurality of decoders, each connected to a single EU 410, or a single decoder (common to EU's 410), which is capable of decoding up to M instruction streams simultaneously. At any given time, only a single instruction set is activated per each of the simultaneously decoded instructions. Namely, decoding means 430 decodes instructions and interprets the instruction opcodes in a way that corresponds to the active instruction-set mode, related to those instructions.

In one embodiment, decoding means 430 is further capable of mapping an instruction of a first instruction set into an instruction of a second instruction set. The first and second instruction sets may be different instruction sets, or the first instruction set may be a subset of the second instruction set. Mode indicator 440 determines the active instruction-set mode, and changes modes according to a programmable mode change message or an external hardware signal.

The mode change message may be at least one of a dedicated instruction, a dedicated combination of instructions, or a dedicated combination of bit-fields within an instruction or within any entity associated with the instruction (e.g. operands, pointers, addresses). It should be noted that in some embodiments mode indicator 440 is not part of processor 400.

In such embodiments, the determination of a change mode is trigger by an external mode indication or using an “address decoder.” The external mode indication signal is fed into decoding means 430 and into EU's 410. The address decoder correlates the memory address of the instruction to be executed and the instruction-set. Namely, the active instruction set mode is determined by the memory location from which the instruction was fetched.

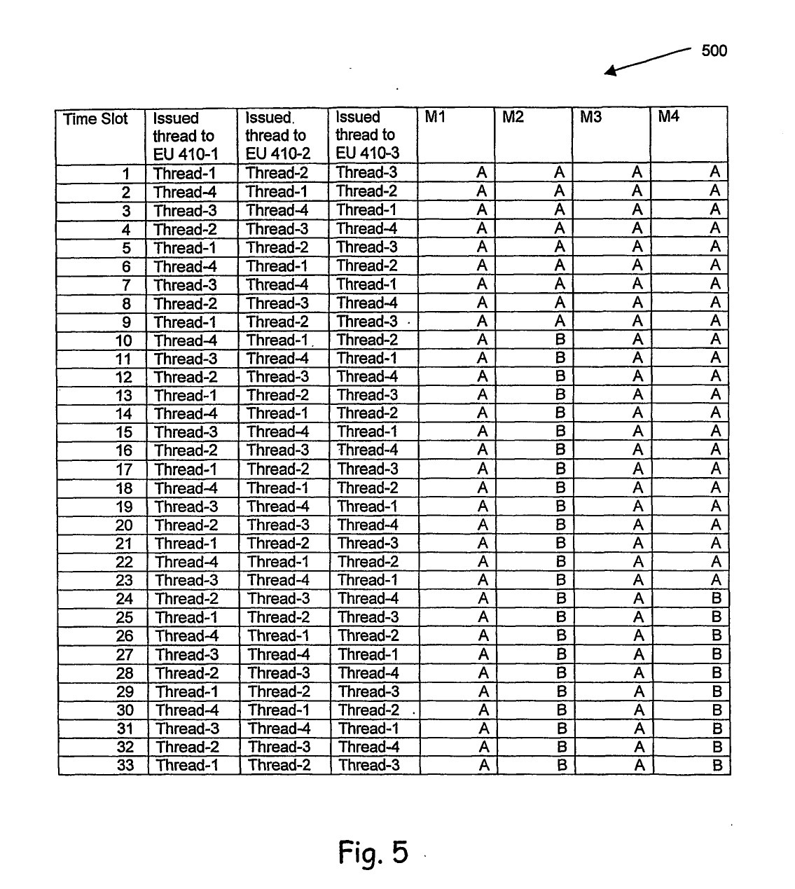

FIG. 5 is a diagram showing an example of a processor 400 executing four threads that belong to two different instruction sets 500. The execution is performed over three distinct EU's: EU 410-1, 410-2 and 410-3. Hence, at each time slot three threads are processed in parallel. The threads are chosen in a round-robin manner, i.e., thread 1 followed by thread 2 and so on.

The example shows the processing of two instruction sets “A” and “B,” where the columns “M1” through “M4” represent the instruction-set mode indicators associated with thread-1 through threads respectively. At startup the instruction-set modes of all threads are set to mode “A.” The time slots represent the execution time given to each thread.

At time slot 1, processor 400 fetches instructions of the active threads thread-1, thread-2 and thread-3 from memory 350, pointed by threads' PC. In addition, DU 450 issues the instruction of the active threads to the different EU's in the following order: instruction from thread-1, thread-2 and thread-3 are issued to EU 410-1, EU 410-2 and EU 410-3 respectively. The fetched instructions are decoded as instruction set “A.”

At time slot 2, processor 400 fetches instructions of the active threads thread-1, thread-2 and thread-4 from memory 350, pointed by threads' PC. In addition, DU 450 issues the instructions of the active threads to the different EU's in the following order: thread-4, thread-1 and thread-2 are issued to EU 410-1, EU 410-2 and EU 410-3 respectively. The fetched instructions are decoded as instruction set “A.” This process is repeated in the same fashion for all threads at time slots 3 through 9.

At time slot 10, when thread-2 is activated, mode indicator 440 updates the instruction-set mode associated with thread-2 to mode “B,” as a result of a mode change message (e.g. “SET B”). Hence, starting from time slot 11, instructions that belong to thread-2 are decoded as instruction-set “B.” The decoding of thread-2 as instruction-set “B” is not dependent on the EU's that execute thread-2. From this point, thread-1, thread-3 and thread-4 run as instruction set “A,” and thread-2 runs as instruction set “B.”

At time slot 24, when thread-4 is activated, mode indicator 440 updates the instruction-set mode associated with thread-4 to mode “B” as a result of mode change message (e.g. “SET B”). Hence, starting from time slot 25, instructions belonging to thread-4 are decoded as instruction-set “B.” Starting from this time slot, until a new mode change message is decoded, thread-1 and thread-3 run as instruction set “A,” while thread-2 and thread-4 run as instruction set “B.” This process continues until the application is terminated. It should be noted that a time slot represents the time in which instructions are issued for execution, and not the time required to complete execution of a single instruction.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A processor capable of receiving a plurality of instruction sets from at least one memory, and being capable of multi-threaded execution of the plurality of instruction sets, said processor comprising:
at least one decoder capable of decoding and interpreting instructions from the plurality of instruction sets;
at least one mode indicator capable of determining an active instruction-set mode, and changing modes according to a software or hardware command; and
at least one execution unit for concurrent processing of multiple threads, each correlated to an instruction-set mode, such that each thread can be from a different instruction set, and such that the processor processes said instructions according to said active instruction-set mode, which is determined by the mode indicator,
thereby allowing concurrent execution of several threads of several instruction sets.

2. The processor of claim 1, further comprising a scheduler, having a scheduling algorithm which may be one of the following types:
round robin;
weighted round robin;
a priority based algorithm;
random; and
a selection algorithm that is based on the status of said processor.

3. The processor of claim 1, wherein said at least one decoder is further capable of mapping an instruction of a first instruction set into an instruction of a second instruction set.

4. The processor of claim 1, wherein a first and a second instruction set are one of the following:
different instruction sets; and
said first instruction set is a subset of said second instruction set.

5. The processor of claim 1, wherein said instruction sets may comprise at least one of the following:
digital signal processing;
reduced instruction-set computer;
MicroSoft™ intermediate language; and
Java bytecodes.

6. The processor of claim 1, further comprising a mechanism for automatically changing said active instruction-set mode.

7. The processor of claim 1, wherein the mode change may be implemented by at least one of:
a dedicated combination of bit-fields within at least one register;
an interrupt;
an external mode indication signal;
by using an address decoder;
a dedicated instruction;
a dedicated combination of instructions;
a dedicated combination of bit-fields within an instruction;
a dedicated combination of bit-fields within one of the following entities associated with the instruction:
operands;
pointers; and
addresses; and
any combination of the above.

8. The processor of claim 1, arranged to provide the processing capability of several different processors, with different programming models, all running in parallel.

9. A processing method for multi-threaded execution of a plurality of instruction sets, said method comprising:
providing a processor capable of receiving a plurality of instruction sets from at least one memory;
decoding and interpreting instructions from the plurality of instruction sets;
determining an active instruction-set mode and changing modes according to a software or hardware command; and
concurrently processing of multiple threads, each correlated to an instruction-set mode,
such that each thread can be from a different instruction set, said processing method processing said instructions according to said active instruction-set mode,
thereby allowing concurrent execution of several threads of several instruction sets.

10. The processing method of claim 9, further comprising providing a scheduler, having a scheduling algorithm which may be one of the following types:
round robin;
weighted round robin;
a priority based algorithm;
random; and
a selection algorithm that is based on the status of said processor.

11. The processing method of claim 9, wherein said decoding and mapping is further capable of mapping an instruction of a first instruction set into an instruction of a second instruction set.

12. The processing method of claim 9, wherein a first and a second instruction set are one of the following:
different instruction sets; and
said first instruction set is a subset of said second instruction set.

13. The processing method of claim 9, wherein said plurality of instruction sets may comprise at least one of the following:
digital signal processing;
reduced instruction-set computer;
MicroSoft™ intermediate language; and
Java bytecodes.

14. The processing method of claim 9, wherein changing said active instruction-set mode can be done automatically.

15. The processing method of claim 9, wherein determining an active instruction-set mode and changing modes according to a software or hardware command may be implemented by at least one of:
a dedicated combination of bit-fields within at least one register;
an interrupt;
an external mode indication signal;
by using an address decoder.
a dedicated instruction;
a dedicated combination of instructions;
a dedicated combination of bit-fields within an instruction;
a dedicated combination of bit-fields within one of the following entities associated with the instruction:
operands;
pointers; and
addresses; and
any combination of the above.

16. The processing method of claim 9, further comprising arranging to provide the processing capability of several different processors, with different programming models, all running in parallel.
